(19) United States
(12) Patent Application Publication
(10) Pub. No.: US 2009/0060516 A1
(43) Pub. Date: Mar. 5, 2009

(54) Signal forwarding system and signal receiver thereof

(76) Inventors: Yueh-Jung Lee Wang, Taipei (TW); Hsu-Kuang Yang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,654

(22) Filed: Sep. 5, 2007

(51) Int. Cl. H04B 10/00

(52) U.S. Cl. 398/112

(57) ABSTRACT

A signal forwarding system and a signal receiver thereof are disclosed. The signal forwarding algorithm is provided so that the photo signal provided by the remote control device can be used to indirectly control the remote application apparatus. The present invention uses the photo transistor to be a photo-detecting element to detect the photo signal provided by the remote control device. The problem of the user being not easy to aim at the signal receiver of the application apparatus is overcome, and the problem of the photo-detecting element being operated by an error signal due to the signal disturbance is also overcome.

### BACKGROUND OF THE INVENTION

1. Field of the Invention

The present invention relates to a signal forwarding system. In particular, this invention relates to a signal forwarding system and a signal receiver thereof.

2. Description of the Related Art

Recently, there is a plurality of electronic apparatuses in every house. Some of the electronic apparatuses need to be controlled by a remote control device, including televisions, video recorders, and players, etc.

Therefore, people need a lot of remote control devices to control each of the electronic apparatuses that need to be controlled by a remote control device.

For example, when the user wishes to control the television, the user usually uses a remote control device (such as an IR emitter) to emit a control signal (a photo signal) to the signal receiver of the television (an IR receiver) for controlling the television. At this time, if the user also wishes to control the video recorder, the user also uses a remote control device to control the video recorder.

By using the control mode described as above, there is a problem. If the video recorder is placed to a location that is not close to the television (that is far away from the television), it is not easy for the user to directly control the video recorder. This means that it is difficult for the user to control the video recorder or aim at the signal receiver of the video recorder.

### SUMMARY OF THE INVENTION

One particular aspect of the present invention is to provide a signal forwarding system and a signal receiver thereof. The signal forwarding algorithm is provided so that the photo signal provided by the remote control device can be used to control the application apparatus that is far away from the user. The present invention uses the photo transistor to be a photo-detecting element to detect the photo signal provided by the remote control device. The problem of the user being not easy to aim at the signal receiver of the application apparatus is overcome, and the problem of the photo-detecting element being operated by an error signal due to the signal disturbance is also overcome.

The signal forwarding system includes a signal receiver for receiving the control signal emitted from the remote control device, a signal processing device for processing the control signal, a signal outputting device for outputting the processed control signal to control the application apparatus. The signal receiver includes at least one photo transistor, and at least one fill-in light device.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the signal forwarding system of the present invention;

FIG. 2 is a circuit diagram of the signal receiver and the signal processing device of the signal forwarding system of the present invention;

FIG. 3 is a schematic diagram of the appearance of the signal receiver of the signal forwarding system of the present invention; and

FIG. 4 is a schematic diagram of the signal forwarding system of the present invention used for controlling a remote application apparatus.

### DETAILED DESCRIPTION OF THE PREFERRED EMBODIMENTS

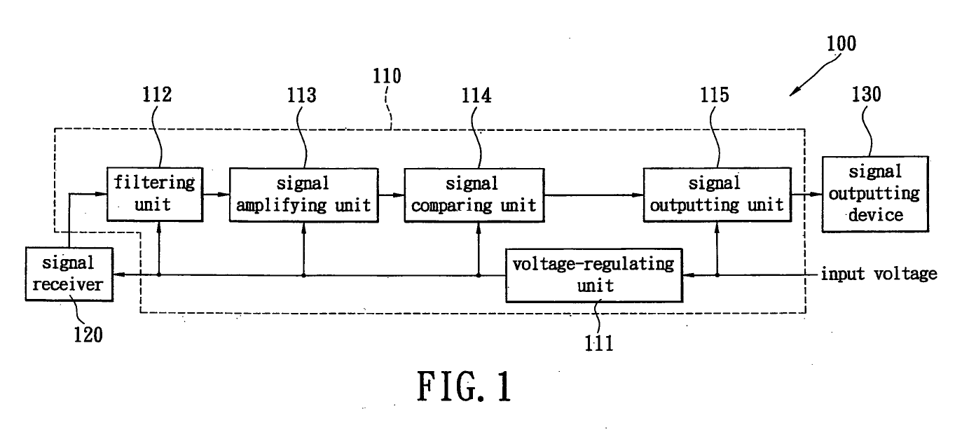

Reference is made to FIG. 1, which shows a block diagram of the signal forwarding system of the present invention. The signal forwarding system 100 includes a signal processing device 110, a signal receiver 120, and a signal outputting device 130.

The signal receiver 120 utilizes the characteristic of the photo detection to receive a control signal provided from a remote control device, such as remote controller, and converts the photo signal into an electrical signal and transmits the electrical signal to the signal processing device 110. The signal receiver 120 includes at least one photo detector, and at least one fill-in light device. The signal receiver 120 can be an IR receiver.

The photo detector is used for detecting the light around the signal receiver 120. The photo detector can be a photo transistor. The present invention uses the photo transistor to be a photo-detecting element due to the photo transistor has a lot of merits, including amplifying and uneasily distorted, etc.

When the photo transistor is used as a photo detector, a stable light source is required for generating the status current at night due to the photo transistor needs an adequate status current. The light provided by the fill-in light device can provide the status current fort the photo detector. The fill-in light device can be a light emission diode.

The signal processing device 110 is connected with the signal receiver 120 for providing the electrical power to the signal receiver 120 and the signal outputting device 130, and processing the signal converted by the signal receiver 120. The signal processing device 110 includes a voltage-regulating circuit 111, a filtering unit 112, a signal amplifying unit 113, a signal comparing unit 114, and a signal outputting unit 115.

The voltage-regulating circuit 111 is connected with a power system and regulates the power provided from the power system to generate voltage levels required for the signal forwarding system 100. Therefore, the voltage-regulating circuit 111 adjusts the voltage levels for each of the elements in the signal forwarding system 100 and then provides the power to the filtering unit 112, the signal amplifying unit 113, the signal comparing unit 114, the signal outputting unit 115, and the signal receiver 120.

The filtering unit 112 is connected with the signal receiver 120 and the voltage-regulating circuit 111 for filtering the signals provided from the signal receiver 120 (an electrical signal converted from the photo signal, a control signal). In this embodiment, the filtering unit 112 is a high-pass filtering circuit. Therefore, the low frequency signal is filtered, and the high frequency signal passes through the filtering unit 112 and is transmitted to the signal amplifying unit 113.

The signal amplifying unit 113 is connected with the filtering unit 112 and the voltage-regulating circuit 111 for amplifying the signals from the filtering unit 112 (the high frequency signals) and the signals is transmitted to the signal comparing unit 114.

The signal comparing unit 114 is connected with the signal amplifying unit 113 and the voltage-regulating circuit 111. The signal comparing unit 114 determines whether the amplified signal is outputted or not according to the amplified signal provided from the signal amplifying unit 113. This means that the signal comparing unit 114 compares the voltage level of the signal with a reference voltage.

When the voltage level of the signal is lower than the reference voltage, the signal received by the signal receiver 120 is not a control signal from the remote control device controlled by the user. This signal is generated fro the light around the signal receiver 120, such as a light from the television, or a light from lamp, etc. Therefore, the output of the signal comparing unit 114 is low (or cut off).

When the voltage level of the signal is larger than the reference voltage, the signal received by the signal receiver 120 is a control signal from the remote control device controlled by the user. The output of the signal comparing unit 114 is high, and the signal is outputted by the signal outputting unit 115.

Finally, the signal outputted from the signal outputting unit 115 drives the signal outputting device 130 for outputting an output signal (photo signal) that corresponds to the control signal to the application device. Therefore, the application device is operated according to the control signal outputted from the remote control device controlled by the user. The signal outputting device 130 can be an IR emitter.

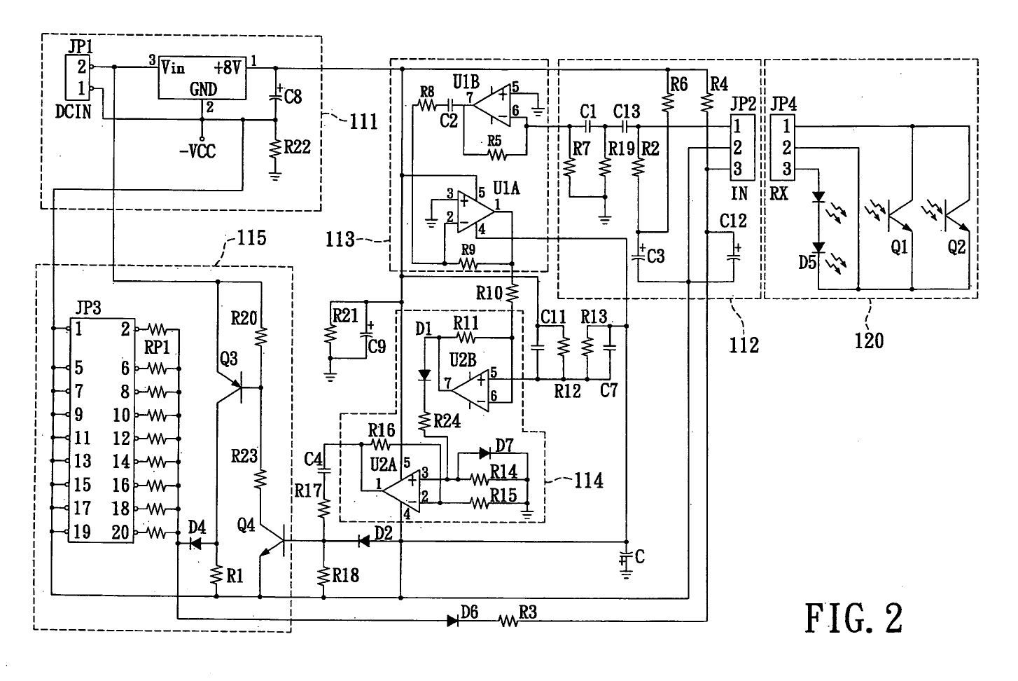

Therefore, the signal processing device 110 prevents an accident operation from occurring due to a photo signal that is not emitted from the remote control device. The signal forwarding system 100 exactly operates. Reference is made to FIG. 2, which shows a circuit diagram of the signal receiver 120 and the signal processing device 110 of the signal forwarding system 100 of the present invention.

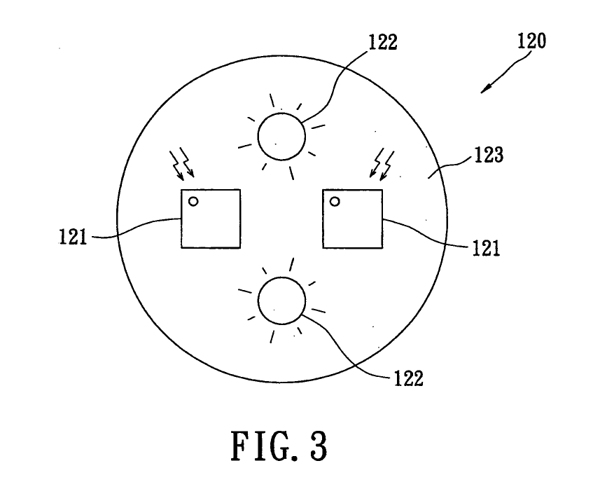

In an embodiment, the signal receiver 120 of the signal forwarding system 100 is shown in FIG. 3. The signal receiver 120 has a pair of photo transistors 121 (photo detector) and a pair of light emission diodes 122 (fill-in light device). The photo transistors 121 and the light emission diodes are located on a substrate 123. FIG. 3 shows a schematic diagram of the appearance of the signal receiver of the signal forwarding system of the present invention. When the light around the signal receiver 120 is not enough and the photo transistors 121 cannot work, the light emission diodes 122 provide an auxiliary light to the photo transistors 121 so that the photo transistors 121 obtains a status current and operates normally.

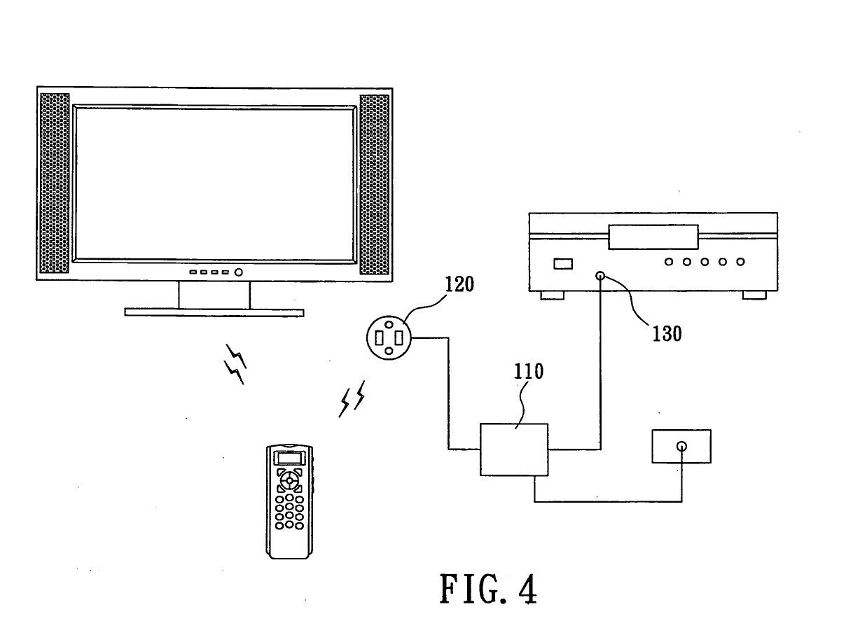

Reference is made to FIG. 4, which shows a schematic diagram of the signal forwarding system of the present invention used for controlling a remote application apparatus. The application for the signal forwarding system 100 is illustrated.

In this embodiment, the signal receiver 120 is located around a signal receiver of a television (not shown in the figure) and is connected with a signal processing device 110 via a cable. The signal processing device 110 is connected with a signal outputting device 130 via a cable. The signal outputting device 130 is located at a signal receiver of a video recorder (not shown in the figure).

When a user uses a remote control device (not shown in the figure) to control the television, the user can use another remote control device (not shown in the figure) to calculate the control signal received by the signal receiver 120 and transmit the control signal to the signal outputting device 130 via the signal forwarding system 100. The signal outputting device 130 outputs a corresponding photo signal according to the signal provided from the signal processing device 110 to control the video recorder connected with the signal outputting device 130.

Although this embodiment uses the television and the video recorder as an example, the scope of the present invention is not limited to above. Whatever application apparatus that can use the signal forwarding system 100 to forward the control signal is within the scope of the present invention. Therefore, the application apparatus can be an electronic apparatus that operates according to the received photo signal, such as a video recorder, a player, or a television, etc.

In this embodiment, the light emission diode is used as the fill-in light device. However, the present invention is not limited to the light emission diode. Whatever the electronic elements that can provide a fill-in light is within the scope of the present invention.

The characteristic of the present invention is that the user can use the signal forwarding system to indirectly control a remote application apparatus. The problem of the use having to aim at the application apparatus is overcome.

Another characteristic of the present invention is that the signal receiver of the signal forwarding system uses the photo transistor to detect the photo signal (control signal) outputted from the remote control device controlled by the user. Therefore, the problem of signal distortion is avoided, and the accident operation due to an environmental light is also avoided.

A further characteristic of the present invention is that the signal receiver of the signal forwarding system uses the light emission diode an auxiliary light source. Therefore, the status current for the photo transistor is provided, and the photo transistor can normally works at night.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A signal forwarding system, for forwarding a received control signal to at least one remote application apparatus to control the application apparatus, comprising:
a signal receiver having a photo detector and a fill-in light device for receiving a control signal emitted from a remote control device;
a signal processing device connected with the signal receiver for calculating and processing the control signal; and
a signal outputting device connected with the signal processing device for outputting the processed control signal to the application apparatus and controlling the application apparatus.

2. The signal forwarding system as claimed in claim 1, wherein the photo detector is a photo transistor.

3. The signal forwarding system as claimed in claim 1, wherein the fill-in light device is a light emission diode.

4. The signal forwarding system as claimed in claim 1, wherein the signal processing device comprises;
a filtering unit for receiving a signal from the signal receiver;
a signal amplifying unit connected with the filtering unit for amplified the filtered signal;
a signal comparing unit connected with the signal amplifying unit for checking the amplified signal and determining whether to output the amplified signal;
a signal outputting unit connected with the signal comparing unit for outputting the signal according the checking result of the signal comparing unit and controlling the signal outputting device; and
a voltage-regulating circuit connected with the signal receiver, the filtering unit, the signal amplifying unit, the signal comparing unit and the signal outputting unit for providing power to connected units.

5. The signal forwarding system as claimed in claim 1, wherein the signal receiver is an IR receiver.

6. The signal forwarding system as claimed in claim 1, wherein the signal outputting device is located at one signal receiving terminal of the application apparatus.

7. The signal forwarding system as claimed in claim 1, wherein the signal receiver is connected with the signal processing device via a cable.

8. The signal forwarding system as claimed in claim 1, wherein the signal processing device is connected with the signal outputting device via a cable.

9. The signal forwarding system as claimed in claim 1, wherein the signal outputting device is an IR emitter.

10. The signal forwarding system as claimed in claim 1, wherein the signal receiver further comprises a substrate, and the photo detector and the fill-in light device are located on the substrate.

11. A signal receiver applied to the signal forwarding system, connected with a signal processing device for receiving a control signal from a remote control device and transmitting the control signal to the signal processing device, the control signal is processed and is outputted to at least one remote application apparatus for controlling the application apparatus, comprising:
at least one photo detector for detecting a light power of the control signal; and
at least one fill-in light device for providing power to the photo detector.

12. The signal receiver as claimed in claim 11, wherein the photo detector is a photo transistor.

13. The signal receiver as claimed in claim 11, wherein the fill-in light device is a light emission diode.

14. The signal receiver as claimed in claim 11, further comprising a substrate, wherein the photo detector and the fill-in light device are located on the substrate.
